(19) United States
(12) Patent Application Publication
(10) Pub. No.: US 2014/0186212 A1
(43) Pub. Date: Jul. 3, 2014

(54) METHODS AND APPARATUS FOR MEASURING LUMINESCENCE AND ABSORBANCE

(71) Applicant: AWARENESS TECHNOLOGY INC., Palm City, FL (US)

(72) Inventors: Gary Freeman, Palm City, FL (US); Daniel Mammolito, Jupiter, FL (US)

(73) Assignee: AWARENESS TECHNOLOGY INC., Palm City, FL (US)

(21) Appl. No.: 14/078,131

(22) Filed: Nov. 12, 2013

Related U.S. Application Data
(60) Provisional application No. 61/725,538, filed on Nov. 13, 2012.

(51) Int. Cl. G01N 21/76

(52) U.S. Cl. CPC G01N 21/76
USPC 422/52

(57) ABSTRACT

An automated chemistry analyzer includes a first fiber optic bundle that is used to guide a signal. The automated chemistry analyzer also includes a photomultiplier detector tube (PMT) that receives the guided signal from the first fiber optic bundle and produces an output PMT signal. The output PMT signal is used by the automated chemistry analyzer to derive chemi-luminescence and absorbance.

### CROSS-REFERENCE TO RELATED APPLICATIONS

This application claims priority to U.S. Provisional Application Ser. No. 61/725,538, filed on Nov. 13, 2012), the entire disclosure of which is hereby incorporated herein by reference in its entirety.

### FIELD OF THE INVENTION

The present invention lies in the field of chemical analysis. The present disclosure relates to a measurement of chemi-luminescence and absorbance.

### BACKGROUND OF THE INVENTION

Chemi-luminescence is the emission of light as a result of a chemical reaction at environmental temperatures. Chemi-luminescence differs from fluorescence in that the light emitted is the product of a chemical reaction rather than the emission of light by a substance that has absorbed light.

The absorbance, i.e., optical density, of a material is a logarithmic ratio of the radiation falling upon a material to the radiation transmitted through a material. Transmission is actually measured and absorbance calculated from it.

Prior art systems used different devices to measure chemi-luminescence and absorbance. For chemi-luminescence devices, a chemical is added to a sample to create photons that are then measured by a special luminometer. This special luminometer is designed to have a very high sensitivity in order to measure very low light levels, possibly down to the level of counting photons.

For absorbance devices, an optical system with a lamp, a filter, and a photodetector is used. The absorbance device determines, at any given wavelength(s) in the white light spectrum, how much light is/are absorbed vs. transmitted through a sample. A photometer using a photodiode can be used to make this determination.

The light levels needed for chemi-luminescence and absorbance devices are significantly different, both optically and electrically. As such, a chemi-luminescence device and an absorbance device have never before been combined in the same system. One reason that can be attributed to this is that the photodiode of prior art systems is simply incapable of performing with the sensitivity necessary for measuring chemi-luminescence. There are many commercially available microwell assays using photometry and many microwell assays using luminescence that are commonly run together as panels. The processing of the two types of assays is very similar up to the final step of optical reading. Typically, a lab requires two separate instruments to process both types of assays, which adds significant cost. Alternately, a lab can use one liquid processing instrument to handle all the steps up to the reading and then use two readers, one of each type, to complete the two assays. This adds labor and introduces timing errors between processing and reading. Significantly, with luminescent assays, the time of readings is critical because the reactions cannot be chemically stopped as with colorimetric assays.

Thus, a need exists to overcome the problems with the prior art systems, designs, and processes as discussed above.

### SUMMARY OF THE INVENTION

The invention provides methods and an analyzer for measuring luminescence and absorbance that overcome the hereinafore-mentioned disadvantages of the heretofore-known devices and methods of this general type and that provide such features with an automated chemistry analyzer.

With the foregoing and other objects in view, there is provided, in accordance with the invention, an automated chemistry analyzer comprising a first fiber optic bundle used to guide radiation and a photomultiplier detector tube (PMT) that receives the guided radiation from the first fiber optic bundle and produces an output PMT signal, the output PMT signal used by the automated chemistry analyzer to derive chemi-luminescence and absorbance.

In accordance with a further feature of the invention, there is provided a scan head associated with the first fiber optic bundle and using the first fiber optic bundle to guide radiation.

In accordance with an added feature of the invention, the scan head is fixed.

In accordance with an additional feature of the invention, the scan head is movable.

In accordance with yet another feature of the invention, there is provided a reaction plate and one or more racks removably attached to the reaction plate, each rack having holes or grooves shaped to hold a respective sample container to be examined by the scan head.

In accordance with yet a further feature of the invention, the scan head is positioned over each sample container to take at least one of a chemi-luminescence and an absorbance reading.

In accordance with yet an added feature of the invention, the scan head is positioned over each sample container to take both chemi-luminescence and absorbance readings.

In accordance with yet an additional feature of the invention, chemi-luminescence readings for a plurality of sample containers occur simultaneously.

In accordance with again another feature of the invention, there is provided a high voltage supply and a second stage amplifier together amplifying the output PMT signal.

In accordance with again a further feature of the invention, there is provided a comparator comparing the amplified output PMT signal to a linearly increasing ramp to trigger a comparator output.

In accordance with again an added feature of the invention, there is provided a timer that is started when the ramp is enabled and takes a timer count when the comparator output is triggered.

In accordance with again an additional feature of the invention, the timer count is converted to provide a chemi-luminescence reading.

In accordance with still another feature of the invention, there is provided a stable reference light emitting diode (LED) used for a reference reading.

In accordance with still a further feature of the invention, there is provided a second fiber optic bundle and a lamp positioned to illuminate at least one fiber of the second fiber optic bundle.

In accordance with still an added feature of the invention, the lamp is off when luminescent readings are being taken and the lamp is on during at least a portion of time when absorbance readings are being taken.

In accordance with still an additional feature of the invention, the lamp is used to take an air reading used as a reference for absorbance readings.

In accordance with another feature of the invention, there is provided a high voltage supply and an amplifier together amplifying the output PMT signal.

In accordance with another feature of the invention, a logarithmic ramp signal is used in an absorbance reading to provide a comparison.

In accordance with a further feature of the invention, there is provided a timer having a timer count that triggers when the logarithmic ramp signal reaches a value of the output PMT signal.

In accordance with a concomitant feature of the invention, the timer count and the air reading are used to calculate absorbance.

Although the invention is illustrated and described herein as embodied in methods and an automated chemistry analyzer for measuring luminescence and absorbance, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a vertical cross-sectional view of an automated chemistry analyzer according to an exemplary embodiment operable to measure both absorbance and luminescent using the same equipment;

FIG. 2 is a perspective view of the automated chemistry analyzer of FIG. 1;

FIG. 3 is a perspective view of a scan head assembly of the automated chemistry analyzer of FIG. 1;

FIG. 4 is a block circuit diagram of the automated chemistry analyzer of FIG. 1;

FIGS. 5A and 5B illustrate a power supply circuit diagram of the automated chemistry analyzer of FIG. 1;

FIG. 6 is a diagram of a method for detecting absorbance and luminescence according to an exemplary embodiment; and

FIG. 7 is a perspective view of an exemplary embodiment of an automated chemistry analyzer.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or 1result). In many instances these terms may include numbers that are rounded to the nearest significant figure.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

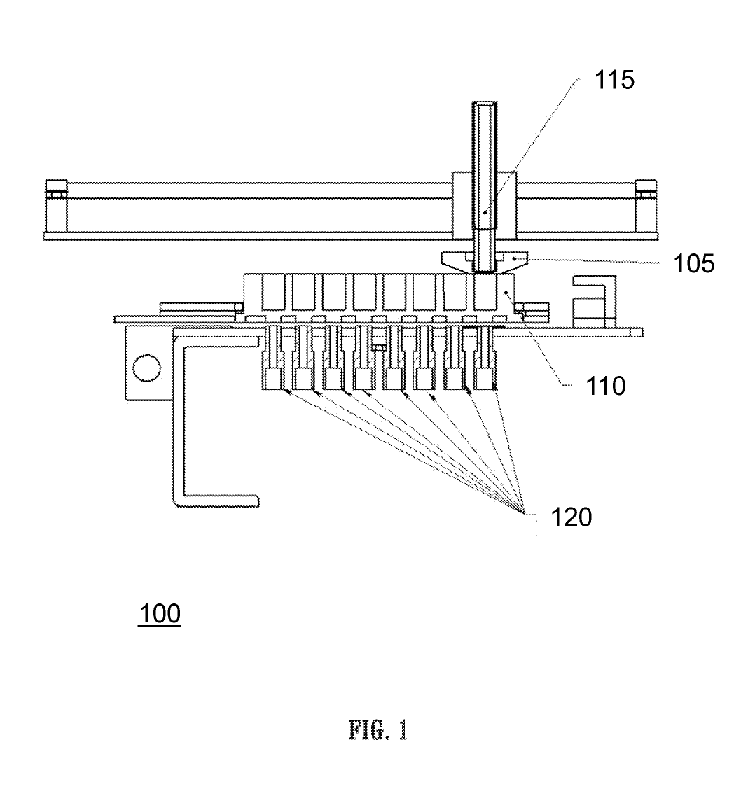

Described now are exemplary embodiments of the present invention. Referring now to the figures of the drawings in detail and first, particularly to FIG. 1, there is shown a first exemplary embodiment of an automated chemistry analyzer 100 capable of measuring both absorbance and luminescent using the one piece of equipment. The automated chemistry analyzer 100 also includes a photometer.

The automated chemistry analyzer 100 is an automated immunoassay analyzer that can read both Chemi-Luminescence and Absorbance using a Photomultiplier Tube (PMT). The automated chemistry analyzer 100 automates precision dilutions of reagent and sample into sample wells on a plate carrier/mover with an integrated dilutor pump. The automated chemistry analyzer 100 may have combined or separate reagent and sample rack movers that position the bottles under the probe assembly. The automated chemistry analyzer 100 can mix, incubate, wash, and add subsequent reagents to the samples as needed before readings are taken.

The microwell plate (also called a reaction plate) and one or more racks move independently toward the front and back of the instrument (into and out of the plane of the drawing of FIG. 1). Each rack has a configuration of holes or grooves operable and shaped to hold different types of tubes, bottles, micro tubes, microwells, and other containers. Different rack configurations are identified utilizing software to indicate to the automated chemistry analyzer 100 which configuration is to be used.

Because the PMT is sensitive to light, the reaction plate must be enclosed in a light-tight compartment. A loading door and an automated top sliding door are provided to allow for dispensing a sample and washing the plate. Both of these doors are closed and the environment is light-tight during readings. Light-tight, as used herein, means that substantially all light from the environment is prevented from entering the area adjacent the photometer 100. Substantially meaning an extent that one having skill in the art would understand does not affect the accuracy of the analyzer.

The plate mover positions the reaction plate 110 under a scan head 105 and above a channel fiber bundle, which are aligned. For absorbance readings, only the channel fiber bundle under the plate supplies the light needed for readings to be made by the scan head 105. It is noted that, because the channels are disposed in a row, the scan head 105 takes the reading and moves linearly across the row. Because each channel is so close to the adjacent channel, it is necessary to focus the light in order to prevent interference from adjacent channels. In addition, a shutter mechanism (not shown) may be used to prevent radiation emitted from adjacent channels propagating to the channel being read in order to eliminate cross talk interference. This may be achieved with a sliding shutter mechanism or a rotational shutter design, with either a solenoid or motor drive.

The photometer of the analyzer 100 is unique in that it utilizes no photodiode. The photometer uses only one PMT to take both absorbance and luminescent readings. In particular, the moving scan head 105 takes both the absorbance and luminescent readings. A plate mover positions a reaction plate 110, e.g., a reaction plate with eight (8) columns in twelve (12) rows, into position under the scan head 105. The reaction plate 110 may be configured to have more or less than eight columns and twelve rows depending the specific configuration needed. The scan head 105 then moves a single fiber optic bundle 115 over each well in that row, in this example, to eight positions in total. The fiber optic bundle 115 that is attached to the scan head 105 then transfers a signal to the PMT (not shown).

In one embodiment, the scan head 105 is fixed. In this embodiment, a plate is positioned using two-dimensional or three-dimensional movement, e.g., in an X-Y plane or an X-Y-Z plane. The plate can be positioned under a single read point in order to read the plate.

To properly measure absorbance readings, a light source is needed under each well. In an exemplary embodiment, this is achieved with the use of an eight-channel fiber optic bundle 120 that is positioned under each well across a row and runs to a non-illustrated filter and lamp assembly. This lamp is turned off when luminescent reads are being taken.

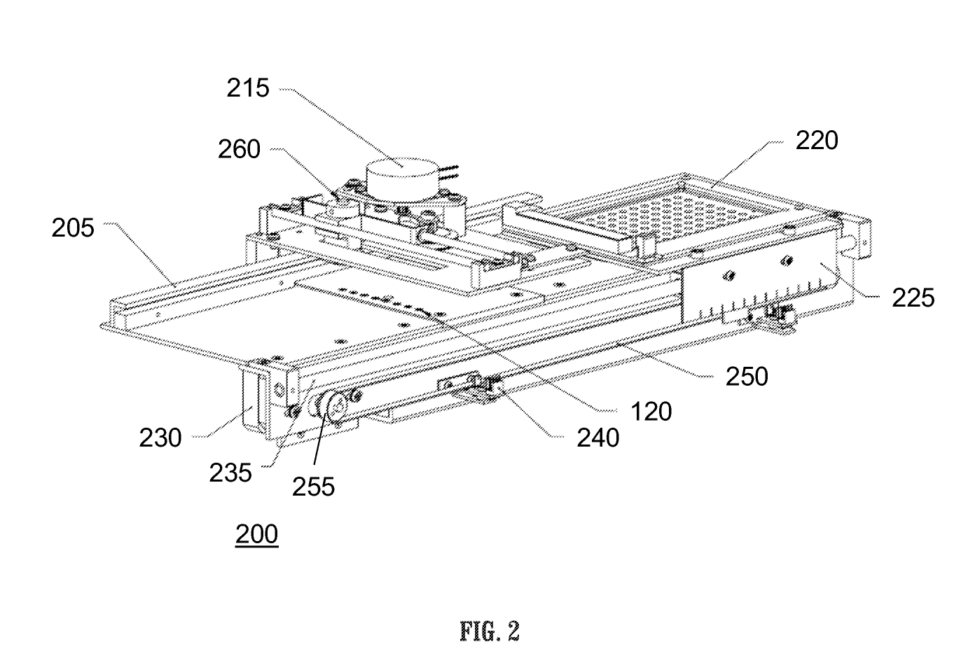

FIG. 2 illustrates a different view 200 of the automated chemistry analyzer/photometer 100. In this view 200, a guide track 205, a motor 230, a guide rod 235, a main drive belt 250, a pulley 255, and a packing plate 225 are used to move a plate carrier 220 longitudinally along the guide track 205. A sample tray, e.g., reaction plate 110, can be installed in the plate carrier 220 removably.

A scan head assembly uses a stepper motor 215 to move the fiber optic bundle 115 over each well in a row of a reaction plate 110. The fiber optic bundle 115 is placed through a top portion 260 of the scan head assembly. The fiber optic bundle 115 is used to transmit absorbance and luminescent readings to a PMT. An optics board 240 and a fiber optic bundle 120 are used to channel light from a lamp assembly to a row of the reaction plate 110 for use in taking absorbance readings. As stated above with respect to FIG. 1, the lamp is turned off when luminescent readings are being taken.

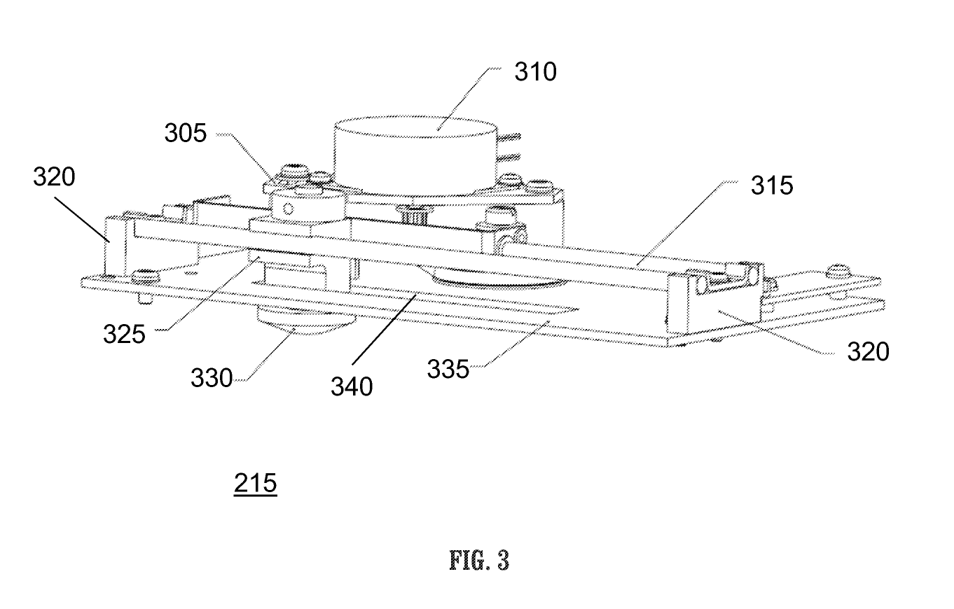

FIG. 3 illustrates the scan head assembly in further detail. The scan head assembly includes a base 335 having attached thereupon guide rod supports 320. Attached to guide rod supports 320 are guide rods 315. Guide rods 315 hold a fiber mount 325 in place. The fiber mount 325 is slidably engaged along the guide rods 315. A bottom portion of the fiber mount 325 includes a floating scan disk 330 disposed underneath the base 335 through an opening 340 in the base. A stepper motor 310 moves the fiber mount 325 and the floating scan disk 330 along the guide rods 315 and the opening 340. The stepper motor 310 is mounted to the base 335 using a motor mount 305.

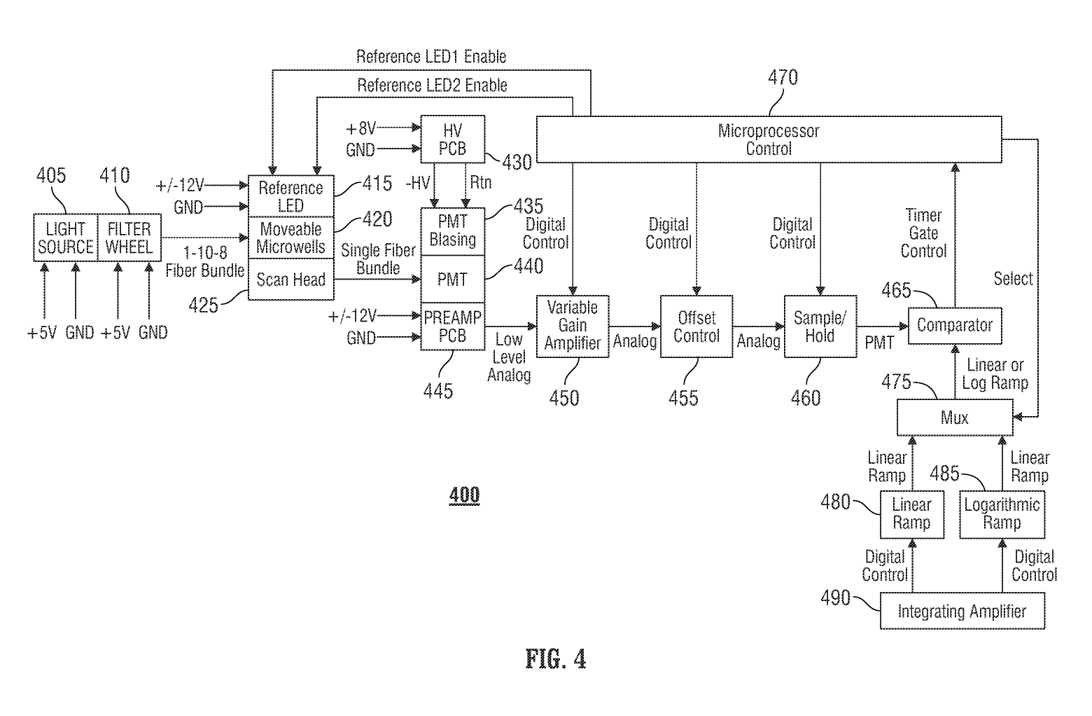

FIG. 4 illustrates a circuit diagram 400 of the photometer 100. The photometer 100 includes a mechanism having a light source 405, filters 410, a PMT detector 440, and electronics that condition and filter the light detected from the PMT 440. A filter wheel 410 has a plurality of optical filters (not shown). In one exemplary embodiment, the filter wheel 410 has four optical filters operable to detect light from four different wavelengths. The filter wheel 410 may be a plastic wheel having four or more optical glass or interference filters. The filter wheel 410 is used in absorbance mode and a determination of which filters are used is based on the type of test being performed.

The scan head 105, 425 then moves a single fiber optic bundle 115 over each well in a row of the reaction plate 110. Once placed in the plate carrier 220, the reaction plate 110 is moveable, e.g., row-by-row, using a moveable micro-well circuit 420. The fiber optic bundle 115 that is attached to the scan head 105, 425 then transfers the signal to the PMT 435. To take into account drift inherent in the PMT 435, a stable reference LED 415 is used for taking a reference reading.

The scan head 105, 425 is configured to minimize crosstalk among the wells, e.g. channels, in a column. Crosstalk is defined as interference from adjacent wells. The light field coming from the channels is restricted both below and above. Crosstalk is related to an acceptance angle of each individual fiber strand, which is 60 degrees. This acceptance angle is too wide and, therefore, could reads interference or crosstalk from other wells. To minimize such crosstalk, a light-restricting spacer is added to the scan head and each of the channels. The spacer has a rough inner surface in order to prevent reflections. In one exemplary embodiment, the spacers are approximately ½″ long and have an inner diameter of approximately 0.140″. In another embodiment, the spacers are approximately 1″ long and have a diameter of approximately 0.089″ to 0.093″. Since the photometer is using less total light, the light is focused or concentrated in order to obtain detectable and distinguishable readings. As the scan head 105, 425 moves from well to well, radiation is guided to the PMT 440 using a fiber optic cable 115. Because the scan head 105, 425 is focused on one well at a time, crosstalk from other wells is avoided. Focusing by the scan head 105, 425 is cost-effective because only one fiber optic bundle needs to be turned on at one time instead of, for example, eight fiber optic bundles for each well in a row.

The analog front end includes the PMT 440 and a trans-impedance amplifier 445. A high-voltage supply 430 is used to supply the photomultiplier cathode, e.g., a PMT biasing circuit 435, with voltage, e.g., between four-hundred (400) and eight-hundred (800) volts. The output of the trans-impedance amplifier 445 is amplified and low-pass filtered through a variable gain amplifier block 450 that is digitally controlled by a microprocessor 470. An electronic potentiometer 455 is used on the output of the variable gain amplifier 450 to provide a DC offset voltage so that the input signal low amplitude range is not affected. The sample voltage is then processed with a sample and hold circuit 460 that holds the sample voltage to a constant value at the input of a voltage comparator 465. The other input of the voltage comparator 465 is connected to a multiplexer 475 that provides a ramp voltage that may either be created by a charging capacitor, e.g., a logarithmic ramp 485, or a linear ramp 480 from the output of an integrating amplifier 490.

In operation, a strobe signal from the microprocessor 470 initializes the sample and hold circuit 460 and the voltage ramp circuit, i.e., multiplexer 475, in combination with linear ramp 480 or charging capacitor 485. When the strobe signal is complete, the sample and hold voltage is held constant and the ramp voltage starts ramping down towards ground. In addition, the microprocessor 470 starts a non-illustrated hardware counter operable to count how many units of time it takes for the ramp voltage to equal the sampled voltage. At that point, the comparator 465 switches and disables the counter using a timer gate control signal. The microprocessor 470 reads the counts from the counter and applies algorithms to the detected sample values to derive either the absorbance or the luminescence of the material being analyzed.

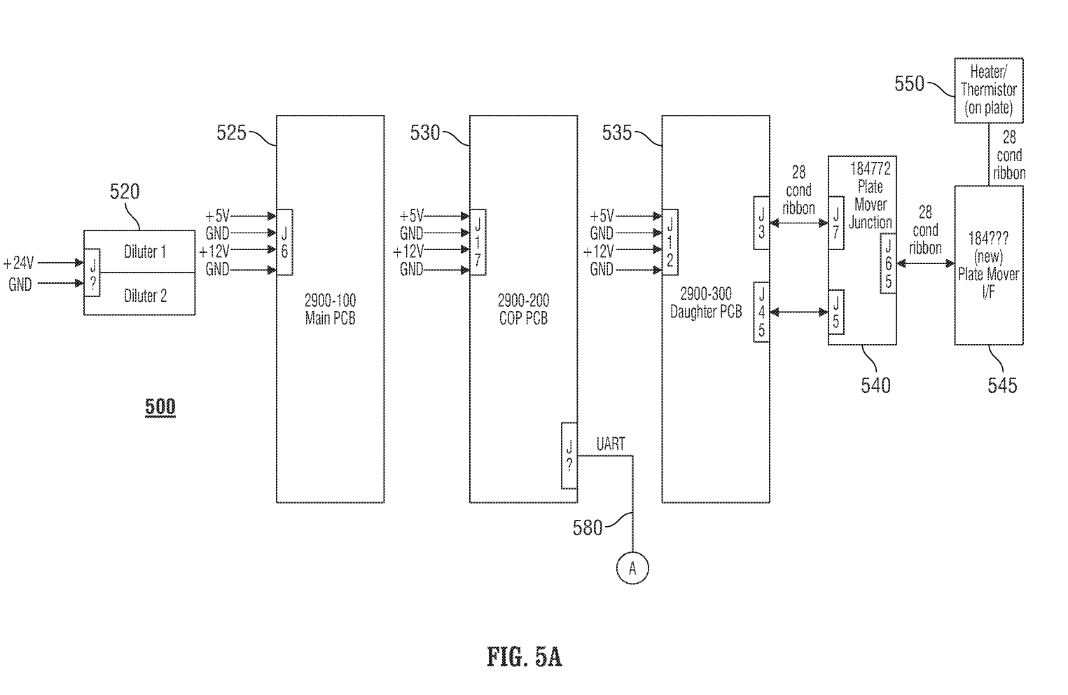

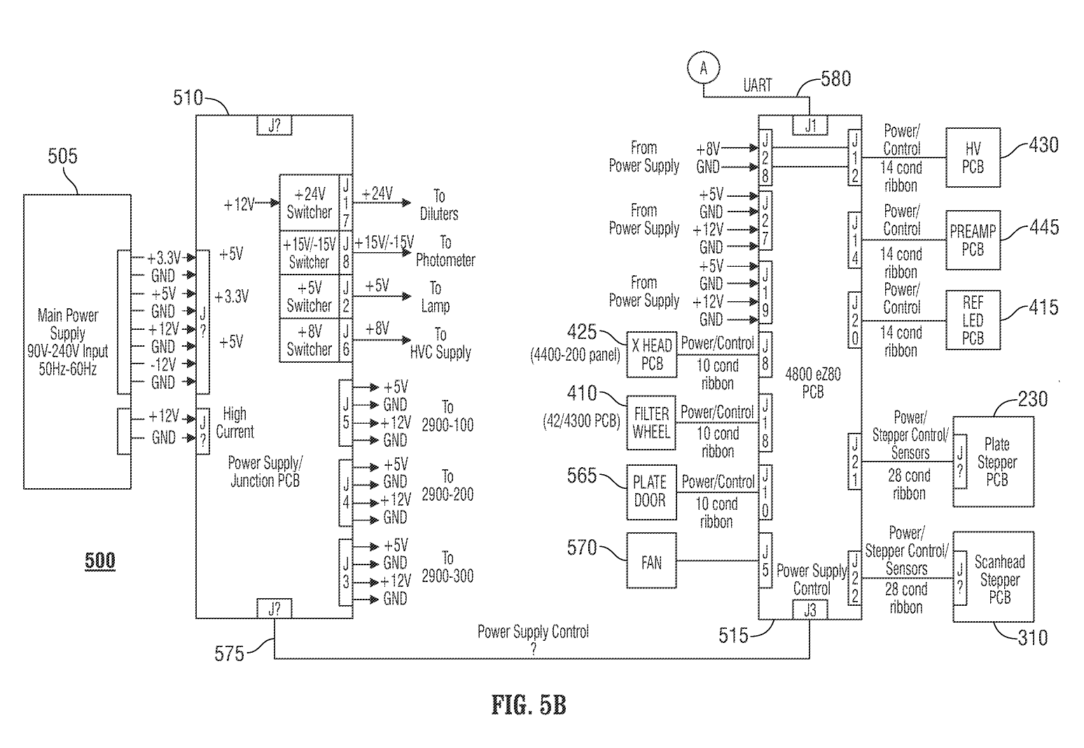

FIG. 5 illustrates a power supply circuit diagram 500 according to one exemplary embodiment of the photometer. A main power supply provides power to a power supply junction 510. The power supply junction 510, in turn, provides power to diluters 520, the photometer 400, 515, a lamp (e.g., light source 405), a high voltage supply 430, and circuits 525, 530, 535. The power supply junction 510 is also able to send/receive power supply control signals to/from the photometer 400, 515 using a power supply control link 575. The circuit 535 provides power to a plate mover junction 540, which, in turn, provides power to a plate mover I/F 545. The plate mover I/F 545 further provides power to a heater/thermistor 550. The circuit 530 and the photometer 515 use a universal asynchronous receiver/transmitter link 580 for data communications. The photometer 400, 515 provides power and control to the high voltage supply 430, the preamplifier 445 (trans-impedance amplifier), the reference LED 415, the scan head 425, the filter wheel 410, a plate door 565, and a fan 570. The photometer 400, 515 provides power for the plate stepper motor 230 and control for associated sensors. The photometer 400, 515 also provides power for the scan head stepper motor 310 and control for associated sensors.

In one exemplary embodiment, the photometer 400, 515 is a separate assembly and a printed circuit board (PCB) (e.g., an eZ80 PCB) controls the plate stepper motor 230.

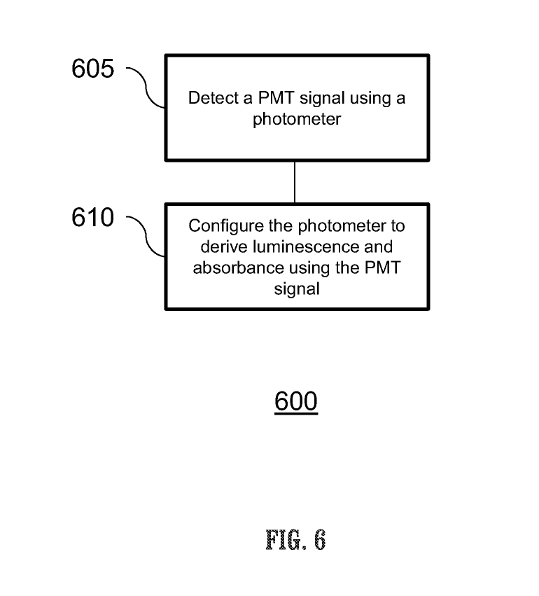

FIG. 6 illustrates a diagram of a method 600 for detecting absorbance and luminescence, according to one exemplary embodiment. At step 605, a PMT signal is detected using the photometer. At step 610, the photometer is configured to derive luminescence and absorbance using the PMT signal.

For luminescent readings, the output PMT signal is amplified using a High Voltage (HV) supply, e.g., HV Supply 430. After passing through a second stage amplifier, e.g., amplifier 450, the signal is compared to a linearly increasing ramp, e.g., from the linear ramp 480. A timer (for counting) is started at the same time the ramp 480 is enabled. When the linear ramp 480 reaches the level of the PMT signal, the comparator 465 output is triggered and the timer count, which may be provided by a timer implemented in software and/or hardware, is taken at that instant. This count is then converted to provide the readings. To take into account drift in the PMT, the stable reference LED 415 is used for taking a reference reading. This reference reading is used for adjusting the count. A reading is also taken in the dark to remove all influence of background noise. This value is subtracted from the raw reading. For luminescence readings, the dark readings are subtracted from all of the raw readings. The reference readings are used to calculate drift in the instrument. Hence, the ratio of the Calibrated Reference Read to the Current Reference Read is first computed. This ratio is multiplied to the (dark/background subtracted) raw reading. In one exemplary embodiment, chemi-luminescence in all adjacent wells of a row occurs simultaneously. As such, scan head 105, 425 must be able to quickly move from well to well in order to obtain proper luminescence readings. It takes about 2.5 minutes to read a plate. Thus, it takes approximately 0.8 seconds to move from one well to another and complete a reading.

For taking absorbance readings, the lamp (e.g., light source 405) is switched to an “on” setting. Because the lamp does not stabilize immediately, a warm up time is provided. The filter wheel 410 is rotated to move the required filter over into place. One or more air readings, which are used as reference, are also taken. The air reading (e.g., an air count) is taken without any plate in the path of the light into the PMT through the fiber. Air readings are taken before absorbance readings. The measurement with no plate or sample in the read path (just air) is used as a baseline for 100% transmission or zero absorbance. The output signal from the PMT is, again, amplified, first, by the HV supply 430 and, later, by the amplifier 450. The logarithmic ramp 485 (e.g., the discharge of a charged capacitor) is used to provide a logarithmically decaying curve for comparison. The timer (e.g., a software or hardware timer) is started upon initiation of the logarithmic ramp and triggers when the logarithmic signal reaches the value of the PMT signal. The obtained timer count along with the air count is used to calculate the measured absorbance.

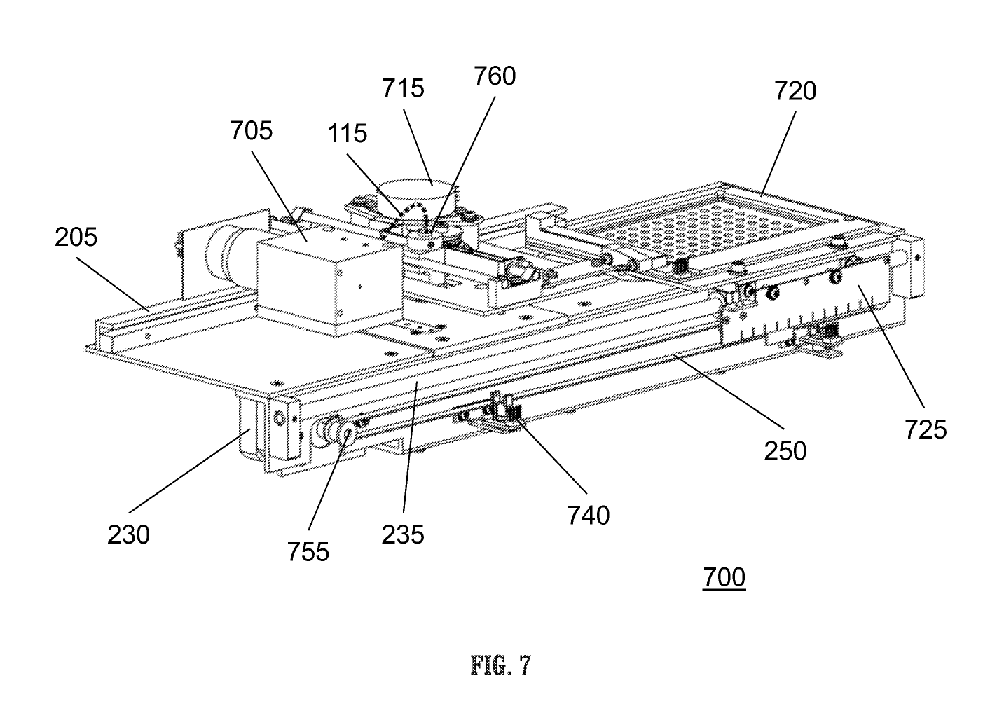

FIG. 7 illustrates another view 700 of an automated chemistry analyzer/photometer. Elements consistent with view 200 retain the same numbering in view 700. In this view 700, a guide track 205, a motor 230, a guide rod 235, a main drive belt 250, a pulley 755, and a packing plate 725 are used to move a plate carrier 720 longitudinally along the guide track 205. A sample tray, e.g., reaction plate 110, can be installed in the plate carrier 720 removably.

A scan head assembly uses a stepper motor 715 to move the fiber optic bundle 115 over each well in a row of a reaction plate 110. The fiber optic bundle 115 is placed through a top portion 760 of the scan head assembly. The fiber optic bundle 115 is used to transmit absorbance and luminescent readings to a PMT 705, e.g., via fiber optic connection 760. An optics board 740 and another fiber optic bundle (not shown due to being obscured by the PMT 705) are used to channel light from a lamp assembly to a row of the reaction plate 110 for use in taking absorbance readings. As stated above with respect to FIG. 1, the lamp is turned off when luminescent readings are being taken.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

1. An automated chemistry analyzer, comprising:
a first fiber optic bundle used to guide radiation;
a single photomultiplier detector tube (PMT) that receives the guided radiation from the first fiber optic bundle and produces a single output PMT signal;
a second fiber optic bundle;
a lamp positioned to illuminate at least one fiber of the second fiber optic bundle, the lamp:
switched to an “on” setting during at least a portion of time when absorbance readings are taken; and
switched to an “off” setting when chemi-luminescence readings are taken;
a scan head associated with the first fiber optic bundle and having a shutter mechanism shaped to reduce crosstalk; and
a microprocessor that receives the single output PMT signal and applies algorithms to derive both chemi-luminescence and absorbance from the signal output PMT signal.

2. The automated chemistry analyzer of claim 1, wherein the scan head uses the first fiber optic bundle to guide radiation.

3. The automated chemistry analyzer of claim 2, wherein the scan head is fixed.

4. The automated chemistry analyzer of claim 2, wherein the scan head is movable.

5. The automated chemistry analyzer of claim 2, further comprising:
a reaction plate; and
one or more racks removably attached to the reaction plate, each rack having holes or grooves shaped to hold a respective sample container to be examined by the scan head.

6. The automated chemistry analyzer of claim 5, wherein the scan head is positioned over each sample container to take at least one of the chemi-luminescence reading or the absorbance reading.

7. The automated chemistry analyzer of claim 5, wherein the scan head is positioned over each sample container to take both chemi-luminescence and absorbance readings.

8. The automated chemistry analyzer of claim 7, wherein chemi-luminescence readings for a plurality of sample containers occur simultaneously.

9. The automated chemistry analyzer of claim 7, further comprising a high voltage supply and a second stage amplifier together amplifying the single output PMT signal.

10. The automated chemistry analyzer of claim 9, further comprising a comparator comparing the amplified single output PMT signal to a linearly increasing ramp to trigger a comparator output.

11. The automated chemistry analyzer of claim 10, further comprising a timer that is started when the ramp is enabled and takes a timer count when the comparator output is triggered.

12. The automated chemistry analyzer of claim 11, wherein the timer count is converted to provide the chemi-luminescence reading.

13. The automated chemistry analyzer of claim 12, further comprising a stable reference light emitting diode (LED) used for a reference reading.

14. (canceled)

15. (canceled)

16. The automated chemistry analyzer of claim 1, wherein the lamp is used to take an air reading used as a reference for absorbance readings.

17. The automated chemistry analyzer of claim 16, further comprising a high voltage supply and an amplifier together amplifying the single output PMT signal.

18. The automated chemistry analyzer of claim 17, wherein a logarithmic ramp signal is used in an absorbance reading to provide a comparison.

19. The automated chemistry analyzer of claim 18, further comprising a timer having a timer count that triggers when the logarithmic ramp signal reaches a value of the single output PMT signal.

20. The automated chemistry analyzer of claim 19, wherein the timer count and the air reading are used to calculate absorbance.

21. The automated chemistry analyzer of claim 1, wherein the first fiber optic bundle and the second fiber optic bundle are opposite each other and are on opposing sides of a sample.

22. An automated chemistry analyzer, comprising:
a first fiber optic bundle guiding radiation;
a single photomultiplier detector tube (PMT) that receives the guided radiation from the first fiber optic bundle and produces a single output PMT signal;
a scan head associated with the first fiber optic bundle and having a shutter mechanism shaped to reduce crosstalk;
a second fiber optic bundle opposite the first fiber optic bundle with respect to the scan head, at least one fiber of the second fiber optic bundle:
being provided with illumination during at least a portion of time when absorbance readings are taken with the PMT; and
not being provided with the illumination when chemi-luminescence readings are taken with the PMT; and
a microprocessor that receives the single output PMT signal and applies algorithms to derive both chemi-luminescence and absorbance from the signal output PMT signal.
